(19) United States
(12) Patent Application Publication
(10) Pub. No.: US 2018/0191671 A1
(43) Pub. Date: Jul. 5, 2018

(54) STRUCTURE OF INTERFACE IDENTIFIER (IID) OF INTERNET PROTOCOL VERSION 6 (IPv6) ADDRESS, METHOD OF DEFINING IID, AND COMMUNICATION DEVICE FOR PERFORMING THE SAME

(71) Applicant: Electronics and Telecommunications Research Institute, Daejeon (KR)

(72) Inventors: Younghwan CHOI, Daejeon (KR); Jung Soo PARK, Daejeon (KR)

(73) Assignee: Electronics and Telecommunications Research Institute, Daejeon (KR)

(21) Appl. No.: 15/584,127

(22) Filed: May 2, 2017

(30) Foreign Application Priority Data
Jan. 4, 2017 (KR) 10-2017-0001377

(51) Int. Cl. H04L 29/12

(52) U.S. Cl. CPC H04L 61/305; H04L 61/2007

(57) ABSTRACT

A structure of an interface identifier (BD) of an Internet Protocol version 6 (IPv6) address, a method of defining the BD and a communication device for performing the method are provided. The structure of the BD may include a “u” bit indicating a uniqueness of the IPv6 address, and FFFE₁₆ bits located in a central portion of the BD.

### CROSS-REFERENCE TO RELATED APPLICATION

This application claims the benefit of Korean Patent Application No. 10-2017-0001377, filed on Jan. 4, 2017, in the Korean Intellectual Property Office, the disclosure of which is incorporated herein by reference.

### BACKGROUND

### 1. Field of the Invention

At least one example embodiment relates to a structure of an interface identifier (IID) of an Internet Protocol version 6 (IPv6) address, a method of defining the BD, and a communication device for performing the method.

### 2. Description of the Related Art

An Internet Protocol version 6 (IPv6) address may include an upper 64-bit prefix address and an interface identifier (BD) corresponding to a lower 64-bit area. The IID may be a device identification (ID) used for identification in a local network. For network identification, the upper 64-bit prefix may be allocated to the IPv6 address, and accordingly a globally unique address of 128 bits in total may be formed.

Methods of transmitting IPv6 packets based on a low power device are being developed by an Internet Engineering Task Force (IETF) 6lo working group (WG). However, among the methods, a method of generating an IPv6 BD for transmission of an IPv6 packet based on a G9959 network, a near field communication (NFC) network and a master-slave/token-passing (MS/TP) network may merely utilize a link layer address of a device and may use a method of matching a lowest unit.

For example, in an NFC, 58 bits corresponding to a front portion of a 64-bit IID may be filled with zeros, and the remaining 6 bits may be appended as an NFC link layer address. An MS/TP network and a G9959 network may use a lower 8-bit link address in the 64-bit IID without a change.

### SUMMARY

Example embodiments may provide a technology of generating an interface identifier (IID) with an enhanced security when an Internet Protocol version 6 (IPv6) address is generated.

According to an aspect, there is provided a structure of an interface identifier (IID) of an Internet Protocol version 6 (IPv6) address, the structure including a “u” bit indicating a uniqueness of the IPv6 address, and FFFE₁₆ bits located in a central portion of the IID.

The “u” bit may be located at a 7^{th} bit of the IID.

The FFFE₁₆ bits may be located at a 25^{th} bit of the IID.

According to another aspect, there is provided a method of defining an IID in an IPv6 address, including defining a “u” bit indicating a uniqueness of the IPv6 address based on a predetermined value in a predetermined location of the IID, and allocating FFFE₁₆ bits to a central portion of the IID.

The defining of the “u” bit may include defining the “u” bit in a 7^{th} bit of the IID. The defining of the “u” bit may include setting the “u” bit to “0” when the IID is universally administered, and setting the “u” bit to “1” when the IID is locally administered.

The allocating of the FFFE₁₆ bits may include allocating the FFFE₁₆ bits to a 25^{th} bit of the IID.

The method may further include defining the HD based on a prefix value of the IPv6 address and a 6-bit address of a near field communication (NFC) link.

The defining of the IID may include generating a base value by performing an exclusive OR (XOR) operation on the prefix value, the 6-bit address, and nonce of a random seed, and generating a first output value by applying a standard hash function to the base value.

The standard hash function may be a secure hash algorithm (SHA)-256 function.

The first output value may be 256 bits. The method may further include generating a second output value by performing an XOR operation on upper 128 bits and lower 128 bits of the first output value, and generating a third output value by performing an XOR operation on upper 64 bits and lower 64 bits of the second output value.

The defining of the “u” bit may include defining the “u” bit in the third output value, and the allocating of the FFFE₁₆ bits may include allocating the FFFE₁₆ bits to the third output value.

According to another aspect, there is provided a communication device including a communication module, and an address generation device configured to acquire a prefix from an IPv6 address through the communication module, to define a “u” bit indicating a uniqueness of the IPv6 address based on a predetermined value at a predetermined location of an IID of the IPv6 address, and to allocate FFFE₁₆ bits to a central portion of the IID.

The address generation device may be further configured to define the “u” bit in a 7^{th} bit of the IID.

The address generation device may be further configured to set the “u” bit to “0” when the IID is universally administered, and configured to set the “u” bit to “1” when the IID is locally administered.

The address generation device may be further configured to allocate the FFFE₁₆ bits to a 25^{th} bit of the IID.

The address generation device may be further configured to define the IID based on a prefix value of the IPv6 address and a 6-bit address of an NFC link.

The address generation device may be further configured to generate a base value by performing an exclusive OR (XOR) operation on the prefix value, the 6-bit address, and nonce of a random seed, and to generate a first output value by applying a standard hash function to the base value.

The first output value may be 256 bits. The address generation device may be further configured to generate a second output value by performing an XOR operation on upper 128 bits and lower 128 bits of the first output value, and to generate a third output value by performing an XOR operation on upper 64 bits and lower 64 bits of the second output value.

The address generation device may be further configured to define the “u” bit in the third output value, and to allocate the FFFE₁₆ bits to the third output value.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating a communication device according to an example embodiment;

FIG. 2 is a diagram illustrating a concept of an operation of defining an interface identifier (IID) in an Internet Protocol version 6 (IPv6) address according to an example embodiment;

FIG. 3 is a flowchart illustrating an operating method of the communication device of FIG. 1;

FIG. 4 is a flowchart illustrating an operation of defining an IID in the operating method of FIG. 3;

FIG. 5 is a flowchart illustrating an operation of defining a “u” bit in the operating method of FIG. 3; and

FIG. 6 is a flowchart illustrating an operation of allocating FFFE₁₆ bits to the IID in the operating method of FIG. 3.

### DETAILED DESCRIPTION

The following structural or functional descriptions of example embodiments described herein are merely intended for the purpose of describing the example embodiments described herein and may be implemented in various forms. However, it should be understood that these example embodiments are not construed as limited to the illustrated forms.

Various modifications may be made to the example embodiments. Here, the examples are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

When it is mentioned that one component is “connected” or “accessed” to another component, it may be understood that the one component is directly connected or accessed to another component or that still other component is interposed between the two components. In addition, it should be noted that if it is described in the specification that one component is “directly connected” or “directly joined” to another component, still other component may not be present therebetween. Likewise, expressions, for example, “between” and “immediately between” and “adjacent to” and “immediately adjacent to” may also be construed as described in the foregoing.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “include/comprise” and/or “have” when used in this specification, specify the presence of stated features, integers, steps, operations, elements, components, and/or combinations thereof, but do not preclude the presence or addition of one or more other features, numbers, steps, operations, elements, components, and/or groups thereof.

Unless otherwise defined, all terms including technical or scientific terms used herein have the same meanings as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, example embodiments will be described in detail with reference to the accompanying drawings. The scope of the right, however, should not be construed as limited to the example embodiments set forth herein. Like reference numerals in the drawings refer to like elements throughout the present disclosure.

A term “module” described herein may refer to hardware for performing a function and an operation to be described hereinafter according to each name of a module, may refer to computer program code to execute a specific function and operation, or may refer to an electronic recording medium, for example, a processor, including computer program code to execute a specific function and operation.

Thus, the term “module” may refer to a functional and/or structural combination of hardware for implementing the technical idea of the present disclosure and/or software for driving the hardware. Each module may be referred to as a “device.”

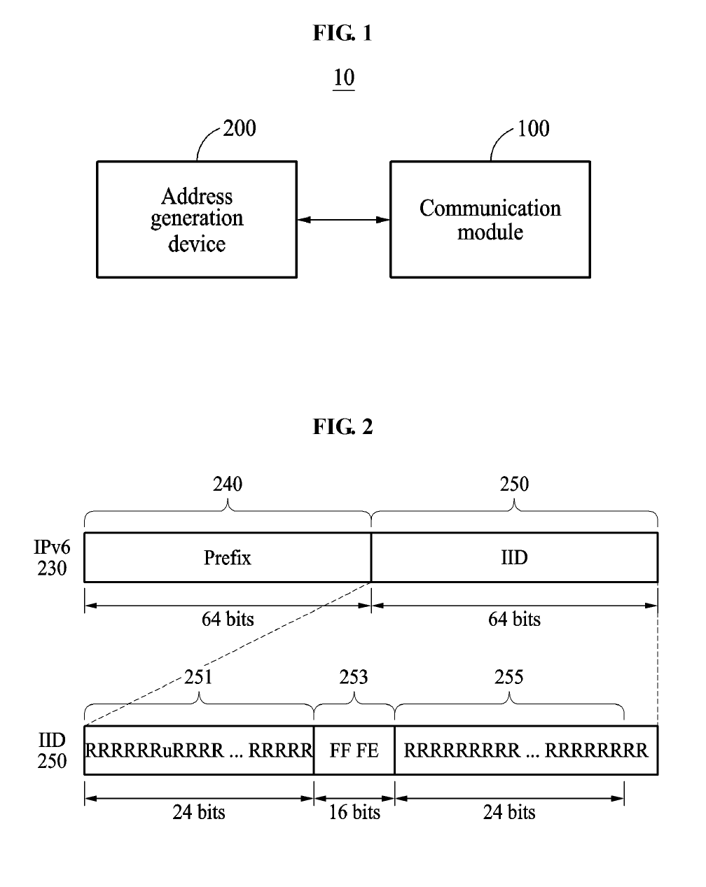

FIG. 1 is a block diagram illustrating a communication device 10 according to an example embodiment, and FIG. 2 is a diagram illustrating a concept of an operation of defining an interface identifier (IID) in an Internet Protocol version 6 (IPv6) address according to an example embodiment.

Referring to FIGS. 1 and 2, the communication device 10 may include a communication module 100 and an address generation device 200.

The communication device 10 may be a low power wireless communication device. For example, the communication device 10 may be a communication device based on a low power wired/wireless network interface technology, for example, G9959, master-slave/token-passing (MS/TP) or near field communication (NFC). The communication device 10 may be implemented as, for example, a personal computer (PC), a data server or a portable device.

The portable device may be implemented as, for example, a laptop computer, a mobile phone, a smartphone, a tablet PC, a mobile Internet device (MID), a personal digital assistant (PDA), an enterprise digital assistant (EDA), a digital still camera, a digital video camera, a portable multimedia player (PMP), a personal navigation device or portable navigation device (PND), a handheld game console, an e-book, or a smart device.

The smart device may be implemented as, for example, a smartwatch or a smart band.

The address generation device 200 may define an IID 250 of an IPv6 address 230.

Referring to FIG. 2, the IPv6 address 230 may include a prefix 240 with a 64-bit length, and the IID 250 with a remaining 64-bit length. The prefix 240 may be an address value used to identify the communication device 10 in a global network, and the IID 250 may be an address value used to identify the communication device 10 in a link local network. Thus, the communication device 10 may generate a globally unique address that is globally identifiable, by forming the prefix 240 and the IID 250.

In other words, the prefix 240 may be an address value used to identify a local network unit, and the IID 250 may be an address value generated to identify devices or terminals in a local network.

The address generation device 200 may acquire the prefix 240 from an upper connection device that is communicable with the communication device 10, through the communication module 100. The prefix 240 may be an address value provided by the upper connection device.

The upper connection device may be, for example, an upper default router. The upper connection device may include a base station, a dongle, an access point (AP) including a router, and the like. For example, the dongle may refer to all wireless dongles connectable to the Internet as well as a universal serial bus (USB) dongle, a Bluetooth dongle, an NFC dongle, a Miracast dongle, and the like. The upper connection device may refer to all devices to provide a network environment for a communication to the communication device 10.

The IID 250 may be 64 bits. An “R” bit area of the IID 250 may correspond to 47 bits. The “R” bit may be a bit based on a 6-bit address source service access point (S SAP) value of a link layer of the communication device 10. For example, the “R” bit may be a bit based on an output value generated by applying a hash function to an SSAP value.

The address generation device 200 may define a first BD 251 and a second IID 255 based on a predetermined value 253 at a predetermined location in the BD 250.

Since the IID 250 is based on a standard of a modified extended unique identifier (EUI)-64, the value 253 may be FFFE₁₆ bits. The FFFE₁₆ bits may be 16 bits in a central portion of a 64-bit area of the IID 250. For example, the FFFE₁₆ bits may be located at a 25^{th} bit of the 64-bit area of the IID 250.

In the IID 250, the first BD 251 and the second BD 255 may be formed as two 24-bit areas based on the value 253.

The address generation device 200 may assign Node ID_1 to the first BD 251 and assign Node ID_2 to the second IID 255, based on a node identification (ID) of the communication device 10. For example, the node ID may indicate a device ID, for example, a link local identifier of a lower physical layer, of the communication device 10.

The address generation device 200 may define a “u” bit in the first IID 251 based on the value 253. The “u” bit may indicate a uniqueness of the IPv6 address 230. For example, when the IPv6 address 230 is unique in the Internet, the “u” bit may be “1.” When the IPv6 address 230 is not unique in the Internet, the “u” bit may be “0.” The “u” bit may be located at a 7^{th} bit of the 64-bit area of the IID 250. In other words, the address generation device 200 may define the “u” bit at the 7^{th} bit of the 64-bit area of the IID 250.

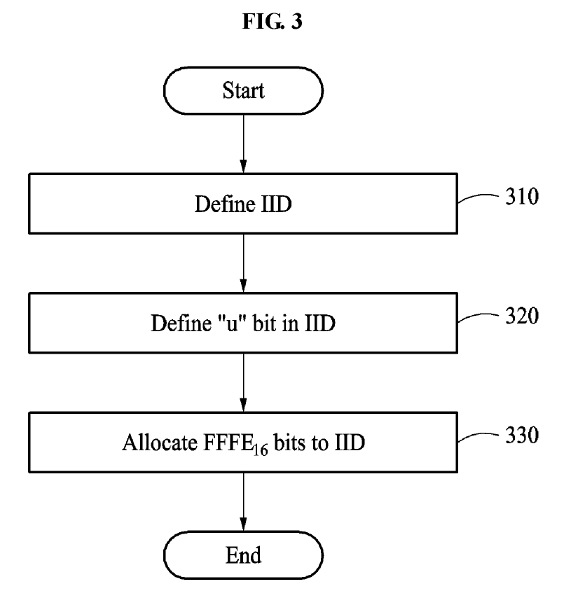

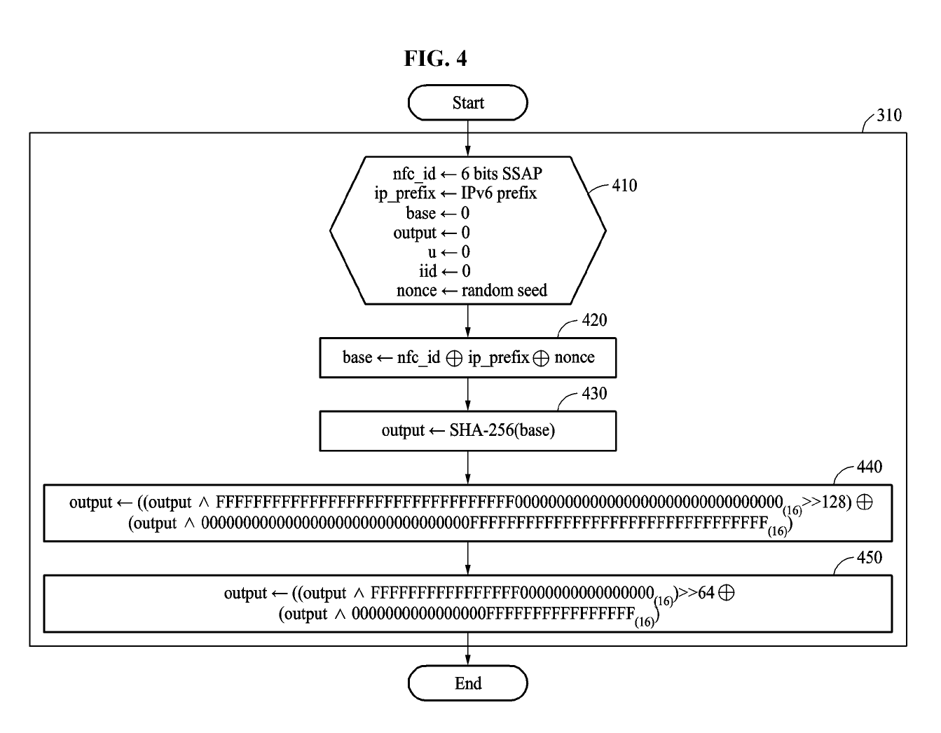

FIG. 3 is a flowchart illustrating an operating method of the communication device 10 of FIG. 1. FIGS. 4, 5, and 6 are flowcharts illustrating the operating method of FIG. 3.

Referring to FIGS. 3 through 6, in operation 310, the communication device 10 may define the IID 250.

In operation 410, the communication device 10 may set initial values of variables required to define the IID 250. The variables may include, for example, at least one of nfc_id, ip_prefix, base, output, u, iid, or nonce. nfc_id may be a 6-bit address of an NFC link, and ip_prefix may be a value of the prefix 240 of the IPv6 address 230, base may be a base value used in a standard hash function to define the IID 250, and output may be a 64-bit output value used to define the IID 250. Also, u may be a bit indicating a uniqueness based on an IPv6 standard in the IPv6 address 230, and iid may be the IID 250 that is generated, and the nonce is a random seed.

The communication device 10 may set nfc_id to a 6-bit SSAP, may set ip_prefix to a value of the prefix 240 of the IPv6 address 230, and may set base, output, u and iid to “0.”

In operation 420, the communication device 10 may set base to a value generated by performing an exclusive OR (XOR) operation ⊕ on nfc_id, ip_prefix, and the nonce.

In operation 430, the communication device 10 may generate a first output value by applying the standard hash function to base and may set output to the first output value. The standard hash function may be, for example, a secure hash algorithm (SHA)-256 function. The communication device 10 may use the standard hash function to enhance a security and prevent hacking.

In operation 440, the communication device 10 may generate a second output value by performing an XOR operation on two 128-bit values obtained by dividing the first output value in half, and may set output to the second output value.

The communication device 10 may use an AND operation to divide the first output value in half. For example, the communication device 10 may extract an upper 128-bit value of the first output value using “output ̂FFFFFFFFFFFFFFFFFFFFFFFFFFFFFFFF00000000000000000000000000000000₍₁₆₎.” The communication device 10 may shift the extracted upper 128-bit value to the right using a bit shift (>>). The communication device 10 may shift the extracted upper 128-bit value to the right by 128 bits.

The communication device 10 may extract a lower 128-bit value of the first output value using “output ̂0000000000000000000000000000000OFFFFFFFFFFFFFFFFFFFFFFFFFFFFFFFF₍₁₆₎.” The communication device 10 may generate the second output value by performing an XOR operation on the shifted upper 128-bit value and the lower 128-bit value, and may set output to the second output value.

In operation 450, the communication device 10 may generate a third output value by performing an XOR operation on two 64-bit values obtained by dividing the second output value in half, and may set output to the third output value.

The communication device 10 may use an AND operation to divide the second output value in half. For example, the communication device 10 may extract an upper 64-bit value of the second output value using “output ̂FFFFFFFFFFFFFFFF0000000000000000₍₁₆₎.” The communication device 10 may shift the extracted 64-bit value to the right using a bit shift (>>). The communication device 10 may shift the extracted upper 64-bit value to the right by 64 bits.

The communication device 10 may extract a lower 64-bit value of the second output value using “output ̂0000000000000000FFFFFFFFFFFFFFFF₍₁₆₎.” The communication device 10 may generate the third output value by performing an XOR operation on the shifted upper 64-bit value and the lower 64-bit value, and may set output to the third output value.

In operation 320, the communication device 10 may define the “u” bit in the third output value.

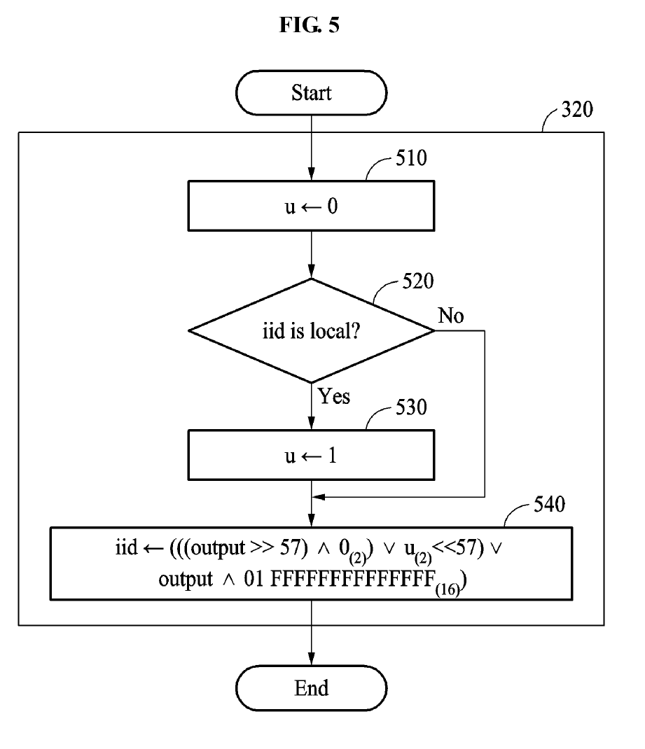

Referring to FIG. 5, in operation 510, the communication device 10 may set u to “0.”

In operation 520, the communication device 10 may determine whether iid is local. Based on whether iid is local or whether the IID 250 is unique in the Internet, the communication device 10 may set u to “0” or “1.”

When iid is local or when the BD 250 is unique in the Internet, the communication device 10 may set u to “1” in operation 530.

When iid is universal or when the IID 250 is not unique in the Internet, the communication device 10 may set u to “0.”

In operation 540, the communication device 10 may define the set u in the third output value. The communication device 10 may shift the third output value to the right by 57 bits. The set u may be located at a 7^{th} bit of the IID 250, and the communication device 10 may reset a value of a 7^{th} bit of the third output value to “0.” For example, the communication device 10 may use “((output>>57)̂0₍₂₎).”

The communication device 10 may perform an OR operation on the set u and the reset value of the 7^{th} bit of the third output value. In other words, the communication device 10 may replace the reset value of the 7^{th} bit of the third output value with the set u. The communication device 10 may shift the third output value including the set u to the left by 57 bits. In other words, the communication device 10 may return the third output value to an original location of the third output value.

The communication device 10 may extract bit values less than or equal to the set u using an AND operation. 57 bits from an 8^{th} bit to a 64^{th} bit may be extracted. For example, the communication device 10 may use “(output ̂01FFFFFFFFFFFFFF₍₁₆₎).”

The communication device 10 may set iid to a value generated by performing an OR operation on the extracted bit values and the third output value that is returned to the original location.

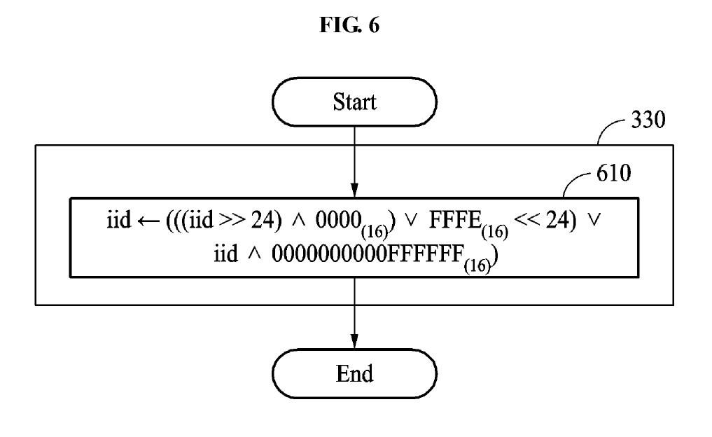

Referring to FIGS. 3 and 6, in operations 330 and 610, the communication device 10 may allocate FFFE₁₆ bits to the third output value.

The communication device 10 may shift iid to the right by 24 bits. The FFFE₁₆ bits may be located at a 25^{th} bit of a 64-bit area of the IID 250, and the set u may be defined in the third output value. Similarly, the communication device 10 may shift iid to the right by 24 bits and may reset a 25^{th} bit to a 40^{th} bit of the third output value to “0.” For example, the communication device 10 may use “((iid>>24)̂0000₍₁₆₎).”

The communication device 10 may perform an OR operation on the FFFE₁₆ bits and the third output value including the reset bits. For example, the communication device 10 may replace the 25^{th} bit to the 40^{th} bit of the third output value reset to “0” with the FFFE₁₆ bits. The communication device 10 may shift the third output value including the FFFE₁₆ bits to the left by 24 bits. In other words, the communication device 10 may return the third output value to the original location.

The communication device 10 may extract bit values less than or equal to the FFFE₁₆ bits using an AND operation. 24 bits from a 41^{st} bit to a 64^{th} bit may be extracted. For example, the communication device 10 may use “(iid̂0000000000FFFFFF₍₁₆₎).”

The communication device 10 may set iid to a value generated by performing an OR operation on the extracted bit values and the third output value that is returned to the original location.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The modules, devices, and other components described herein may be implemented using a hardware component, a software component and/or a combination thereof. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A structure of an interface identifier (IID) of an Internet Protocol version 6 (IPv6) address, the structure comprising:
a “u” bit indicating a uniqueness of the IPv6 address; and
FFFE₁₆ bits located in a central portion of the IID.

2. The structure of claim 1, wherein the “u” bit is located at a 7^{th} bit of the IID.

3. The structure of claim 1, wherein the FFFE₁₆ bits are located at a 25^{th} bit of the IID.

4. A method of defining an interface identifier (IID) in an Internet Protocol version 6 (IPv6) address, the method comprising:
defining a “u” bit indicating a uniqueness of the IPv6 address based on a predetermined value in a predetermined location of the IID; and
allocating FFFE₁₆ bits to a central portion of the IID.

5. The method of claim 4, wherein the defining of the “u” bit comprises defining the “u” bit in a 7^{th} bit of the IID.

6. The method of claim 4, wherein the defining of the “u” bit comprises:
setting the “u” bit to “0” when the IID is universally administered; and
setting the “u” bit to “1” when the IID is locally administered.

7. The method of claim 4, wherein the allocating of the FFFE₁₆ bits comprises allocating the FFFE₁₆ bits to a 25^{th} bit of the IID.

8. The method of claim 4, further comprising:
defining the IID based on a prefix value of the IPv6 address and a 6-bit address of a near field communication (NFC) link.

9. The method of claim 8, wherein the defining of the IID comprises:
generating a base value by performing an exclusive OR (XOR) operation on the prefix value, the 6-bit address, and nonce of a random seed; and
generating a first output value by applying a standard hash function to the base value.

10. The method of claim 9, wherein the standard hash function is a secure hash algorithm (SHA)-256 function.

11. The method of claim 9, further comprising:
generating a second output value by performing an XOR operation on upper 128 bits and lower 128 bits of the first output value; and
generating a third output value by performing an XOR operation on upper 64 bits and lower 64 bits of the second output value,
wherein the first output value is 256 bits.

12. The method of claim 11, wherein
the defining of the “u” bit comprises defining the “u” bit in the third output value, and
the allocating of the FFFE₁₆ bits comprises allocating the FFFE₁₆ bits to the third output value.

13. A communication device comprising:
a communication module; and
an address generation device configured to acquire a prefix from an Internet Protocol version 6 (IPv6) address through the communication module, to define a “u” bit indicating a uniqueness of the IPv6 address based on a predetermined value at a predetermined location of an interface identifier (IID) of the IPv6 address, and to allocate FFFE₁₆ bits to a central portion of the IID.

14. The communication device of claim 13, wherein the address generation device is further configured to define the “u” bit in a 7^{th} bit of the IID.

15. The communication device of claim 13, wherein the address generation device is further configured to set the “u” bit to “0” when the IID is universally administered, and configured to set the “u” bit to “1” when the IID is locally administered.

16. The communication device of claim 13, wherein the address generation device is further configured to allocate the FFFE₁₆ bits to a 25^{th} bit of the IID.

17. The communication device of claim 13, wherein the address generation device is further configured to define the IID based on a prefix value of the IPv6 address and a 6-bit address of a near field communication (NFC) link.

18. The communication device of claim 17, wherein the address generation device is further configured to generate a base value by performing an exclusive OR (XOR) operation on the prefix value, the 6-bit address, and nonce of a random seed, and to generate a first output value by applying a standard hash function to the base value.

19. The communication device of claim 18, wherein
the first output value is 256 bits, and
the address generation device is further configured to generate a second output value by performing an XOR operation on upper 128 bits and lower 128 bits of the first output value, and to generate a third output value by performing an XOR operation on upper 64 bits and lower 64 bits of the second output value.

20. The communication device of claim 19, wherein the address generation device is further configured to define the “u” bit in the third output value, and to allocate the FFFE₁₆ bits to the third output value.
